(19) United States
(12) Patent Application Publication
(10) Pub. No.: US 2004/0253358 A1
(43) Pub. Date: Dec. 16, 2004

(54) Novel anisotropic dough platform for food items

(76) Inventors: Mohamed M. Morad, Marshall, MN (US); Nagwa Zaki Sadek, Ypsilanti, MI (US)

Correspondence Address: MERCHANT & GOULD PC, P.O. BOX 2903, MINNEAPOLIS, MN, 55402-0903, US

(21) Appl. No.: 10/462,083

(22) Filed: Jun. 13, 2003

(51) Int. Cl. A21D 10/00

(52) U.S. Cl. 426/549

(57) ABSTRACT

A convenient, easily consumed, filled food article can be made. The filled food article comprises a first and a second planar edible layer. The article can be made of a planar food component having a unique texture. The layers are combined and sealed at their periphery forming an interior zone that can contain an appropriate filling. The food can be used for a sweet or savory food suitable for consumption at breakfast, lunch, dinner, as a snack, appetizer or other instance. The planar food component is made using a novel recipe and process that results in a planar bready layer that can be readily and easily joined at the periphery with conventional layers and with similar layers. Once made, the food item is easily baked or reheated subject to microwave energy or other forms of heat or other forms of heating and can be consumed at the user's convenience.

### FIELD OF THE INVENTION

The invention relates to a filled food having one, two or more, generally planar food components in the form of a layer forming an envelope that surrounds the filling. Joining one or more of the planar food components into the envelope forms an envelope surrounding a filling. In one embodiment, a single layer can be folded over itself and filling and joined peripherally to form an envelope. The food having two or more layers can be joined peripherally and can contain a filling within the formed envelope. The food item is made from two or more generally planar food components in the form of bread-like layers having a unique texture and surface character. The planar food components can be configured, with other optional planar components, for rapid and secure peripheral joining to enclose a filling. The invention relates to the planar food component layer used in forming the filled food item, the filled food item, methods of making the planar food component structures and methods of developing the food item.

### BACKGROUND OF THE INVENTION

Bready foods having sweet and savory fillings including vegetables, fruits, or pizza mixtures, including cheese, have been common in the prior art for some time. Such products have had some market success because of the attractiveness of combining savory or cheese fillings and bread portion or layer in a product. Products having a sweet or savory filling surrounded by bready layers are shown in a variety of patents. As a whole, such products using this general product profile use two basic formats. Such a product can be made by extruding a uniform dough envelope around a central core of a filling or the product can be made by layering a filling between two substantially uniform bread or crust layers. The extruded or layered products can be further processed or cooked variously.

Extruded products are exemplified by the disclosure in Ramnarine, U.S. Pat. No. 4,888,192, which shows a product and method for extruding a baked good wherein a nozzle is formed to permit extrusion of a dough material surrounding a filler material that is extruded from the same device. The mechanism is carefully adjusted to ensure that the filled material is carefully positioned, preferably centered, within the extrudate leaving a peripheral dough exterior. Daouse, U.S. Pat. No. 5,750,170 discusses a process for producing filled dough products. The patent teaches a co-extrusion of a single filling within a dough layer that is then subsequently sealed and cut in a continuous production scheme. Coleman et al., U.S. Pat. No. 6,210,723 show a baked food product surrounding a co-extruded cheese-filling center. The dough is yeast raised wheat flower dough enclosing a cheese filling made using melt processed cheese materials and other additive ingredients. Lastly, Hartman U.S. Pat. No. 6,406,731 teaches a frozen co-extruded yeast bread product containing a filling. The filled unrisen co-extruded material can be thawed, raised and baked to form a breading product having an intact filling.

Layered products are exemplified by Hong et al., U.S. Pat. No. 4,693,899, show an “over and under” product in which a pizza filling is placed between two layers of pizza dough, the over and under product is then compressed and sealed to form a pizza product. Other prior art references show both cooked and uncooked materials as a layering material.

A substantial need has existed for some time for a new product platform that has the unique ability to be useful in a vast array of useful foods, comprise simple recipes, use straightforward processes and equipment, involve shortened preparation periods and reduce capital costs for space and equipment.

### BRIEF DISCUSSION OF THE INVENTION

We have found a bread-like product enclosing a filling, comprising a sweet or savory composition within a novel envelope. The filling is held within the envelope or enclosure. The envelope comprising cooked dough or a bready layer. The envelope or enclosure of the invention relates to a unique planar food component platform that can be adapted to a variety of foods. The platform involves a food unit and a method for making the food unit from the planar food component. The invention, in its broadest sense, comprises planar food component with a bread-like structure having a first side and a second side. The first side differs from the second side in a product attribute that causes a side to be joined to itself, to a similar layer and to other different but typically edible layers. The planar food component bread-like structure can be sized for a single individually sized food unit that can be applicable to an appetizer size, an entree size, etc. the food unit can be formed in a multiple serving size that can be divided and distributed to a number of consumers. The planar food component is manufactured by first preparing an aqueous based leavened flour based formulation, forming a layer of the formulation on a heated surface, applying heat anisotropically to the layer, substantially gelatinizing the starchy components in the surface in contact with the heated surface leaving the opposite surface, exposed to reduced heating, with minimal gelatinization or substantially partial gelatinization in the starchy components. The side not directly heated has a degree of gelatinization less than the directly heated side. Such a planar food component can be closed upon itself, over a filling, to join the edges. The minimally gelatinized or partially gelatinized surface acts as a site of attachment. The layers combine in a face-to-face relationship in a contact zone of the ungelatinized or partially gelatinized layers to form a bond cohesively. Further cooking of the layers form a solid cohesive joint. The product can be directly combined with an edible layer such either a conventional crust or bread layer or with a second similar planar food component enclosing or surrounding a filling portion to form the food unit. This platform can be used in a batch, continuous or semi-continuous process. In continuous processing, the planar food component can formed into continuous sheets, can be cut into a useful shape and combined with edible layers or similarly shaped units and a filling to form a food unit that can be conveniently eaten by a consumer.

The unique nature of the partially or semi-gelatinized layer results in the ability to combine or bond the planar component with itself or another edible component another planar food components and seal the units at their periphery for the purpose of creating an interior space that can be the location of a sweet, savory or other filling. Once formed the food unit can be immediately consumed, stored, frozen or distributed. The manufactured food can be at least partially cooked after the sealing procedure. The food unit can then be heated conventionally to complete its cooking, if needed, can be stored and distributed in commercial avenues of commerce and then reheated using conventional thermal, convection ovens, microwave energy, toasters, toaster ovens or other sources of heat for the purpose of completing the cooking of the item for ease of consumption. Products of the invention include sandwiches having sandwich components or spreadable materials, pastry items having fruits, creams, chocolate or other fillings, appetizers comprising egg rolls, pizza fillings and other easily eaten finger foods. Such materials can be toasted, fried, microwave baked or otherwise baked, cooked, reheated, etc. to form a final edible food unit.

A first aspect of the invention is the planar food component having a first substantially gelatinized and a second partially gelatinized surface. A second aspect of the invention is a method of making the planar food component. A third aspect of the invention is a finished food item having one planar food component unit joined with itself or another different but edible layer combined in the food unit enclosing an internal filling. A fourth aspect of the invention is a finished food item having two or more of the planar food components enclosing a filling. Lastly, a final aspect is a process for manufacturing the finished food unit including the planar food component.

In this disclosure, the term “gelatinize, gelatinization, either partially or fully” relates to the state of the starch material with respect to water. As starch material is heated in the presence of water, the starch material can combine with water and gelatinize. Gelatinization is indicated visually when the material becomes substantially less viscous or begins to hold its shape when an ungelatinized material would tend to flow. The tendency of starch to combine with water and gelatinize under the effects of heat is a well-known process for gelatinizing starchy materials, particularly in aqueous starch dispersions, doughs or batters. In this product, the fully gelatinized first layer provides mechanical stability to the component and permits the operators to handle the material easily without contamination. The second partially gelatinized layer permits the easy formation of the planar food component with other materials, fillings, etc. into a sealed food unit. The partially gelatinized face or side of the planar food component is ideal for the purpose of bonding or joining the planar food component to itself, to another edible layer or to a similar planar food component for the purpose of enclosing a filling to form an edible item or food unit.

### BRIEF DISCUSSION OF THE DRAWINGS

FIG. 1 is a cross section of one embodiment of the invention involving a filling surrounded by two layers of the planar food component of the invention. The periphery of the planar food components is sealed to ensure that the filling does not leak from the envelope.

FIGS. 2 to 4 are graphs of the viscosity of the dispersion that is cooked to form the planar materials of the invention showing an increase in viscosity with an increase in heating a cooked degree.

### DETAILED DISCUSSION OF THE INVENTION

A planar food component of the invention can be made by forming an aqueous flour based dispersion, applying the dispersion to a heat source and anisotropically heating the dispersion causing the heated side to gelatinize leaving the indirectly heated or less heated side partially gelatinized. Such a material is ideal for the manufacture of food items by combining the planar food component with a filling, closing the food component upon itself to form the item, combining the planar food component with a second edible layer or combining the planar food component with a second similar component in a sealed food item. In such a fashion, the planar food component can act as a envelope or container that surrounds the filling resulting in an easily handled, conveniently cooked edible appealing food item having an attractive appearance and tasty and desirable food quality.

The degree of gelatinization can be measured with the Amylograph an analytical device.

As described below, the aqueous leavened flour mixture can be formed into a sheet or layer and exposed to an isotropic heat source. The heat source then bakes or cooks the aqueous mixture into a completed planar food component. During the baking process, the starch that is directly heated by the heating source is gelatinized so that the structure is consolidated into a useful manageable structure. The starch or gluten content of the flour employed will bind water contained in the dispersion and react with water during the baking process. The starch or gluten is denatured and crosslinked contributing to the strength and texture of the product. In the making of the planar food structure, the mechanical strength and stability of the unit depends largely on the consolidation of carbohydrate and protein materials and by the partial or complete gelatinization of the starch material. Gelatinization begins above 50° C., typically at about 55-65° C. or higher depending on starch source and formulation. Gelatinization can occur at a rate depending on temperature only if heat forces starchy material to combine with water present in the material. With a sufficient amount of water and an appropriate amount of starchy materials, the side of the layer exposed to the heat rapidly gelatinizes and acts to consolidate and stabilize the planar unit mechanically. A substantial heat gradient is created from the heat source through the thickness of the planar food component. The planar food component is exposed to the heat for a sufficient time to substantially gelatinize the first side but to only partially gelatinize the second side leaving, as a result of the heat of the difference in temperature or heat gradient across the planar unit, a reduction in the degree of gelatinization from the surface directly exposed to the heat source through the layer to the surface furthest from the heat source. The material must be heated sufficiently so that the first side is substantially gelatinized, but the second side is only partially gelatinized.

The nature of the planar food component, its manufacture and combination with other planar components, fillings or other edible structure provides a efficient and convenient degree of moisture control to ensure that the filling is maintained in an attractive and edible form, the exterior envelope is maintained in an attractive, stable and edible form. Since the planar food component is at least partially cooked before combination and can be cooked after assembly, the tendency of moisture to migrate from the cooked dough into the filling or from the filling into the cooked dough, obtaining an overly moist or soggy product, is simply avoided in the invention. Attaining a full gelatinization of the first surface of the planar food component and at least a partial gelatinization throughout the rest of the planar food component effectively controls moisture in the envelope, while obtaining a filling with the appropriate moisture content or water activity in contact with the planar component, ensures that excess water if not present in and does not alter the food quality.

In preparing the food of the invention, a leavened formulation is typically formulated in the form of an aqueous dispersion of a starchy component in an aqueous medium. Leavening agents can be chemical or biological sources of CO₂. Typical examples of chemical leavening agents include baking soda, which interacts with an acid source present in the dough, and baking powder, which is a self-contained leavening agent containing both dry soda and dry acid which react together upon dissolution in water. In this instance, soda is typically defined as sodium bicarbonate, although other compounds such as monocalcium phosphate and sodium aluminum sulfate are also useful. In any event, the acid and soda react to form carbon dioxide; which is a gas which provides the necessary leavening. Conversely, a typical biological leavening agent is yeast, which consists of cells of selected strains of the microorganism Saccharomyces cerevisiae. As the cells metabolize sugars or other simple carbohydrates (present in the dough) under anaerobic conditions (common within doughs), carbon dioxide is evolved.

Useful components of such dispersion are flour, water, yeast leavening and sugar to activate and feed the yeast. Additional ingredients can be used including dough conditioners, emulsifiers, and other components. The aqueous dispersion is typically flavored to match the planar food component with the filling. Accordingly, sweet fillings are typically combined with a sweet formulation in preparation of the planar component. Further, savory fillings such as meats, spicy tomato based fillings, spicy egg mixtures, etc. can be enclosed in a formulation that is manufactured with a spice or flavor compatible with the savory fillings. Modem fortified flours are preferable. The yeast employed is generally an active dry yeast, but an instant acting dry yeast is preferred, since the aqueous dispersion is rapidly cooked suggesting that quick acting yeast is helpful in forming the planar food component of the invention.

With a yeast-leavened formulation, the formulations typically include sugar or other carbohydrate that can serve as a source of energy for yeast. Further, sugar is important to ensure that the formulation flavor is matched to the filling. Preferred sugar is dextrose, sucrose, high fructose corn syrup or other common, sweet, mono-, di- or oligosaccahrides or other carbohydrate sources. The amount of sugar, in summary, acts as a flavoring, a food source for the yeast and also acts as a humectant to some degree helping to maintain moisture in the food in an attractive form. Fillings formulated for use with the planar food component of the invention are designed to match moisture activity and flavor of the planar food formulations. Excess water activity will tend to soften or render the planar food component soggier.

The partial gelatinization character of these materials is the characteristic that creates a degree of cohesive nature in the surface of the partial gelatinized starch. This cohesive nature permits an easy assembly of either an edible layer and a planar food component or two of the planar food components into the finished product with a filling portion formed within the food. While secondary adhesive materials are not always needed for mechanical stability of the cohesive bond or joint, in certain instances an adhesive spray can be useful. The partially gelatinized surface forms an cohesive bonding surface that can form a cohesive joint or bond with many types of foods and in particular another similar food unit. The unique nature of the surface permits the planar food components to be joined at the periphery. At the periphery, the partially gelatinized surface contacts, bonds or joins to the opposite surface in a bonding zone and can easily become co-mingled with opposite layers or partially gelatinized materials leading to a secure bonding. The joint can be made more secure with mechanical compression or upon the addition of further heating. Such additional heating then causes further gelatinization of the co-mingled portions resulting in a secure mechanically stable, dimensionally stable, reliable joint. Such a joint can maintain the filling within the envelope during final manufacturing steps, packaging, storage, distribution, retail sales, home use and final consumption.

The aqueous liquid dispersion used in forming the planar food component of the invention typically is an aqueous based formulation comprising flour, salt, sugar, yeast and other components. Chemical leavening agents can be used along with spices and other ingredients. One generic formulation for the aqueous dispersion of the invention is as follows:

Generic Formulae for Aqueous Dispersion
for Formation of Planar Food

| | Useful | Preferred |
|---|---|---|
| Dry Ingredients | % (on flour) | % (on flour) |
| Cake flour | 100 | 1000 |
| Salt | 1-10 | 1.5-8 |
| Sugar | 1-15 | 1.5-12 |
| Yeast | 1-18 | 1.2-15 |
| Baking Powder (Single or Dbl) | 0-5 | 0.1-4 |
| Spice | 0-5 | 0.1-4 |
| Liquid Ingredients | % (on flour) | % (on flour) |
| Water | 100-200 | 100-180 |
| Vegetable oil | 0.5-10 | 0.8-8 |
| Solid Fat | — | 0.1-10 |

The invention relates to a food unit that comprises at least one planar food component and a filling. The planar food component can be arranged or formed into an envelope that fully surrounds the filling as described above. The properties of the planar food component make it ideal for the convenient manufacture of quantities of food having a variety of fillings encased in a variety of envelope textures and flavors. The products of this type have a filling that is encased or enclosed in a bread-like casing described above.

The resulting product has a fresh-tasting texture that includes a fully cooked and gelatinized outer crust or surface and a softer internal texture surrounding the filling, the filling having its own distinctive flavor and character. The invention in the form of a food item is adapted for easy freezing and reheating, can be further cooked after manufacture by thermal ovens, convection ovens, deep frying, griddle frying or other heat driven cooking means. Other products that can be made using the planar food component of the invention can be both sweet and savory. Sweet foods include desserts.

The fillings used in combination with the planar food component of the invention are typically flowable or thickened, stable mixtures of materials. The typical formulation is often flowable but cooks into a workable filling mixture. The moisture content (water activity A_{w}) of the fillings are typically about 1 to 30 wt % water. The food materials that are combined in the formulations can include sweet materials including sugar, fruits, vanilla, chocolate, maple, etc. Savory ingredients used in the fillings can include such materials as meats, vegetables, eggs, cheeses, fish and other similar savory ingredients. The fillings can have an identifiable flavor character including Oriental, South Asian, Thai, Indian, middle Eastern, Mediterranean, Mexican, Southwestern, Hawaiian, etc. Specific and easily identifiable formulations can be used in the invention including cheese, pizza fillings, peanut butter and jelly fillings, toasted cheese fillings, coconut, and coconut seafood, barbeque and variations, sausage and sausage combinations, vegetables and combinations, Black bean, etc. Sweet fillings include fruit, Chocolate, honey, honey walnut, etc. The fillings are often thickened by using a water associating starchy material including such materials as a modified starchy component that can be obtained from a variety of sources. Such sources include maize, maize from a waxy source, corn, arrowroot, and other materials. Such starches and modified starches are known to be highly effective thickening materials that can render the filling handleable and easily cooked.

Savory fillings include a savory spiced toast, a savory meat filling, a savory fish, a savory egg formulation, a savory vegetable mix, a combination of vegetable pieces, cheese, spices, etc. Meats useful in the fillings of the invention include beef, chicken, turkey, veal, pork, prepared meat products such as ham, sausage, salami, pastrami, etc. Common firmer fishes can be used including salmon, sole, shrimp, lobster, in a raw piece form or in a cooked form. Vegetables that can be used in the filling include peas, tomatoes, peppers, mushrooms, onions, potatoes, carrots, celery, etc. Cheeses useful in the savory fillings of the invention include mozzarella, cheddar, parmesan, American, brie, gruyere and others. Sauce used with the fillings of the invention can include prepared materials including mustard, tomato sauce or tomato paste, ketchup, soy sauce, teriyaki sauce or other prepared flavored sauces or materials.

Sweet fillings can include whole fruits or fruit pieces, fruit puree, fruit jam, strawberries, raspberries, blueberries, cherries, blackberries, apples, pear, pineapple, apricot, sweet sauces such as pie filling, caramel, custard, etc.

The preparation of the planar food component of the invention and combining the planar food component with a filling are typically initiated by first preparing a formulation of the aqueous dispersion that is then first exposed to an isotropic heat source and then baked into the planar food component having varied degrees of gelatinization on the cooked and uncooked surfaces. In the manufacture of the aqueous dispersion, the dry ingredients are often combined and then carefully mixed with the dry mix materials. The viscosity of the dispersion is noted and adjusted to ensure that the formulation, when placed on a heat source, spreads to form a layer having a thickness of about 2 to 30 millimeters, 3 to 25 millimeters or 5 to 15 millimeters and a diameter that is typically optional depending on filling formulation and end use. However, conveniently, the diameter of the material can be about 5 to 100 centimeters, 7 to 50 centimeters or 10 to 35 centimeters. In one option, the formulation is formulated to a viscosity such that the material can be added, in a continuous flow onto a heated drum to form a layer about 5 to 35 mm or 8 to 25 mm in thickness. The heated drum can anisotropically apply heat to the formulation. In such a process, the aqueous formulation is applied to a large heated drum and the thickness of the formulation is controlled either by controlling viscosity or by mechanically doctoring the thickness of the add-on formulation to obtain the right thickness. The flow of the aqueous formulation and the rate of rotation of the drum is matched to ensure that the formulation in contact with the heated surface of the drum is substantially gelatinized resulting in a material that can be removed from the drum, handled and then processed and combined with fillings in the manufacture of the food item of the invention. Once cooked, the continuous planar food component of the invention can then be cut into smaller units that can then be processed into the food items of the invention. The continuously cooked planar component can be cut into square, rectangular, triangular, circular, oval or other shapes depending on end use. Alternatively, the planar food component in the form of an intermediate length of material having a width of about 25 to 300 cm can be simply cut into a useful exterior profile or shape, generally a regular form such as a circle, oval, square, rectangular or similar portion for the purpose of ease of handling, then either combined with fillings in a multiple application of fillings, combined with a second square layer and then processed into multiple food items using a multi-unit die structure. Alternatively, the continuous planar food component of the invention can be cut into individual portions that are then immediately processed into individual filled food items.

Regardless of the mode of forming the planar food component that is combined with the filling, the planar unit is obtained in an appropriate size and combined with a predetermined portion of filling placed on the planar food component. Once the filling is applied, the planar food component can be closed over the filling resulting in an envelope that completely surrounds the filling. Typically, the periphery of the planar food component is compressed with a heated or unheated compression to utilize the self-assembling or cohesive nature of the partially gelatinized surface of the planar food component. In any event, the assembled food item can then be further cooked, frozen, packaged or otherwise prepared for distribution and consumption.

In another mode, once the filling is applied to the planar food component, in any arbitrary shape or size, a different edible layer can be bonded or joined to the periphery of the planar food component to fully surround the filling. Such edible layers can include bread layers, crust layers, pita bread, pancakes, both hard and soft tortillas, cooked or uncooked pasta or any other edible material in a planar form having a thickness of less than about 20 mm. The self-assembling nature of the partially gelatinized layer ensures that the layer can quickly joins or bonds to commonly available edible layers to form the envelope surrounding the filling.

In a last mode of the invention, the planar food component of the invention containing a portion of filling can be combined with a second planar food component, the edges sealed with a heated or unheated sealing means to form the final food item of the invention. Preferably, the planar components are similar in size and shape.

These different modes of forming the final food product show a remarkable versatility in obtaining new and different structures. Generally, the weight ratio of the filling to the planar food component or combination of planar food component with other edible layers and other food components will be typically about 1 part by weight of total content of planar food component to about 0.2 to 5 parts by weight of the filling. Preferably, the ratio is about 1 to about 3:1 planar component content:filling. These ratios may be broadly used depending on the filling, the formulation and flavorings in the planar food component.

In the manufacture of the planar food component of the invention from the aqueous dispersions of materials, the dispersions typically applied to a heated surface at a temperature of about 275 to 400° F. Typically, the material is maintained in contact with the food surface until the first surface of the planar food component is fully or substantially gelatinized. Such a substantial gelatinization can be obtained in about 5 to about 60 seconds depending on temperature, weight of add-on portion, thickness of portion and water content. Care must be taken such that the second surface, not directly exposed to the heat from the heat source, is only partially gelatinized to ensure that the second surface maintains a substantially cohesive character. The second surface of the planar food component can be tested by a probe contacting the partially gelatinized layer and qualitatively measuring the cohesive nature of the second layer to any probe or implement in contact with the second layer. If the second layer becomes gelatinized and dried, it is simply too fully cooked to obtain the self-assembling or bonding character required in product assembly. However, a partially gelatinized, partially dried layer maintains sufficient water outside of the gelatinized components to obtain an bonding quality in the planar food component. Once the food item of the invention is assembled as described above, the food item can be directly sent to a consumer for enjoyment, can be frozen for further processing, can be packaged fresh and distributed in commerce. Frozen materials can often be packaged and combined in large numbers and distributed to a use locus at remote distances from the manufacturing site.

In terms of the aqueous dispersion formulation for forming the planar food component of the invention, the formulations can be typically developed by first forming a dry mix which is then combined with a wet mix. Dry mix ingredients typically comprise about 55 to 65 wt % flour, about 1 to 10 wt % sugar or other natural sweetener and about 1 to 12 wt % of a chemical leavening agent or an instant acting dry yeast product. The wet component of the formulations typically involves a mixture of water and high quality vegetable oil. Blending and mixing about 100 to 200 parts by weight water and about 0.5 to 10 parts by weight of oil can obtain such a mixture. Both the dry and liquid components of the formulation can contain other desirable ingredients including spices, fat sources, nuts, fruits, vegetables and other materials that can be included in the planar food component that match the filling flavor and character.

The food product, if not eaten immediately after production, can be taken to a place of consumption, reheated and then enjoyed by a consumer. When reheated, the food item of the invention can be baked, cooked in a microwave oven, baked in a convection oven or a combination of ovens, can be deep fried, can be griddle fried or otherwise heated or reheated to a desirable temperature. Often heating food material to greater than 160° F. for a period of time can help ensure quality and wholesomeness.

When served, the food item can be served with sauces that are selected such that they are compatible with the planar food and its filling. Sweet sauces are typically combined with sweet food items, while savory sauces can be used with savory materials.

### DETAILED DESCRIPTION OF THE DRAWINGS

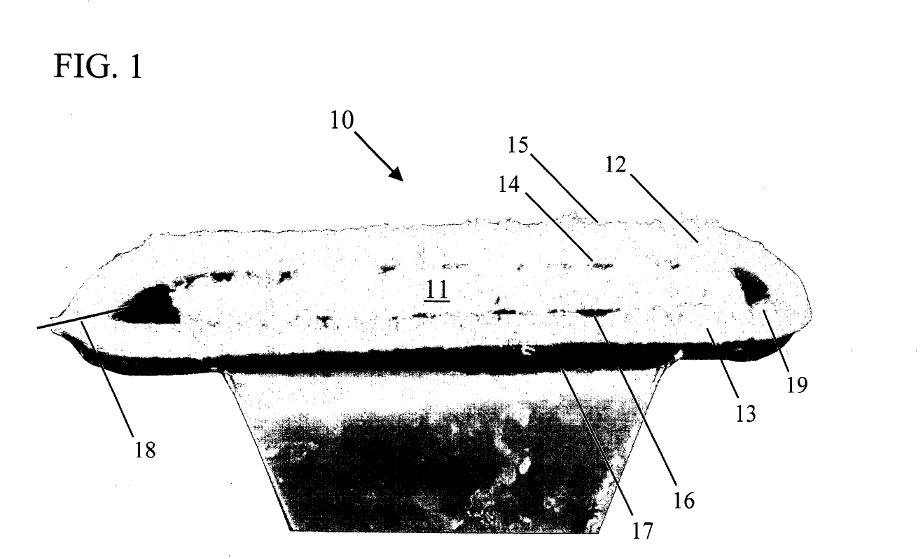

FIG. 1 is a cross section of the food item of the invention. Such a food item 10 encloses a filling component 11. The filling component 11 is fully surrounded by an envelope made by joining a top layer 12 to a bottom layer 13 at a peripheral joint 19 surrounding the circular food. In FIG. 1, a substantially circular top layer 12 is placed onto bottom layer 13 that has been pre-assembled with the filling 11. Once applied to the filling 11 and bottom layer 13, the top layer 12 is then boned to the bottom layer 13 at the periphery of the circular food. The periphery can be compressed and heated to ensure that the cohesive quality of the second layer of layers 12 and 13 form a durable mechanically stable joint forming the envelope surrounding the filling 11. The top layer 12 has an inner surface 14 and an outer surface 15. The bottom layer 13 has an inner surface 16 and an outer surface 17. The outer surface 15 and 17 of the layers 12 and 13 are substantially fully cooked and are substantially gelatinized such that they present an exterior surface that can be easily handled without contamination of the user by the food. The interior surface 14 and 16 of the layers 12 and 13 are the partially gelatinized second surfaces that have cohesive qualities and aid in assembling and sealing the food product of the invention forming an envelope that surrounds filling 11.

The following exemplary section set forth of formulations that have been prepared and cooked into the planar food component of the invention. These components have been combined with the fillings that are also set forth below to form a useful product. The following examples further exemplify the invention and contain a best mode.

### Experimental

### Dispersion Formulations

### EXAMPLE 1

Procedure:

1. Mix dry ingredients together: 500 g cake flour, 4% yeast, 1% double acting baking powder, 4% sugar, 3% salt and 3% shortening.

2. Add 900 g water.

3. Mix together for about 5 min to form dispersion.

4. Ferment 35 min.

5. Pre-heat heat source: ±350°

6. Cook time: 2 oz. of dispersion is about 1 min. 45 sec. @ 350°

1 oz. of dispersion is about 1 min. 30 sec. @ 350°

The surface in contact with the heat source is cooked until dry and mechanically stable. The exposed surface is moist and shows substantial bonding, assembling quality.

### EXAMPLE 2

Procedure:

1. Mix dry ingredients together: 375 g cake flour, 125 g pastry flour, 1% double acting baking powder, 4% sugar, 3% salt, 3% shortening and 4% yeast.

2. Add 900 g water

3. Mix together for about 5 min to form dispersion.

4. Ferment 35 min.

5. Pre-heat heat source: ±350°

6. Cook dispersion as above.

The surface in contact with the heat source is cooked until dry and mechanically stable. The exposed surface is moist and shows substantial cohesive quality.

### EXAMPLE 3

Procedure:

1. Mix dry ingredients together: 400 g cake flour, 200 g Semolina, 15 g salt, 20 gm sugar, 20 g yeast, 5 g double acting baking powder,

2. Liquid ingredients: 925 g water and 15 g soybean oil.

3. Ferment for 30 min.

4. Pour on heat source: ±350

The surface in contact with the heat source is cooked until dry and mechanically stable. The exposed surface is moist and shows substantial cohesive quality.

### EXAMPLE 4

Procedure:

1. Mix dry ingredients together: 500 g Semolina flour, 15 g salt, 20 g sugar, 20 gm inst. yeast and 5 gm double acting BP

2. Liquid ingredients: 1000 g water and 15 g soybean oil.

3. Mix well

4. Let sit 30 min.

5. Pour on heat source: ±350

The surface in contact with the heat source is cooked until dry and mechanically stable. The exposed surface is moist and shows substantial cohesive quality.

### EXAMPLE 5

Procedure:

1. Mix dry ingredients together: 500 g cake flour, 15 g salt, 20 g sugar, 20 g inst. yeast, 5 g double acting BP and 25 g cheese powder.

2. Liquid ingredients: 900 g water and 15 g soybean oil.

3. Mix well

4. Let sit 30 min.

5. Pour on heat source: ±350

The surface in contact with the heat source is cooked until dry and mechanically stable. The exposed surface is moist and shows substantial cohesive quality.

### EXAMPLE 6

Procedure:

1. Mix dry ingredients together: 500 g pastry flour, 15 g salt, 20 g sugar, 20 g inst. yeast and 5 g double acting baking powder

2. Liquid ingredients: 900 g water and 15 g soybean oil.

3. Mix well

4. Let sit 30 min.

5. Pour on heat source: ±350

The surface in contact with the heat source is cooked until dry and mechanically stable. The exposed surface is moist and shows substantial cohesive quality.

### EXAMPLE 7

Procedure:

1. Mix dry ingredients together: 500 g cake flour, 25 parmesan cheese, 15 g salt, 20 g sugar, 20 g inst. yeast and 5 g double acting baking powder.

2. Liquid ingredients: 900 g water and 15 g soybean oil.

3. Mix well

4. Let sit 30 min.

5. Pour on heat source: ±350

The surface in contact with the heat source is cooked until dry and mechanically stable. The exposed surface is moist and shows substantial cohesive quality.

### EXAMPLE 8

Procedure:

1. Mix dry ingredients together: 500 g cake flour, 15 g salt, 20 g sugar, 20 g inst. yeast, 5 g double acting BP, 5 g garlic powder and 1.5 g malt barley.

2. Liquid ingredients: 900 g water and 15 g soybean oil.

3. Mix well

4. Let sit 30 min.

5. Pour on heat source: ±350

The surface in contact with the heat source is cooked until dry and mechanically stable. The exposed surface is moist and shows substantial cohesive quality.

### EXAMPLE 9

Procedure:

1. Mix dry ingredients together: 500 g cake flour, 15 g salt, 25 g sugar, 30 g yeast, 5 g double acting baking powder, 1.5 g malt barley and 5 g garlic powder flavor.

2. Liquid ingredients: 820 g water, 15 g soybean oil,

3. Mix 5 min.

4. Let sit 30 min.

5. Pour on heat source: ±350

The surface in contact with the heat source is cooked until dry and mechanically stable. The exposed surface is moist and shows substantial cohesive quality.

The following formulations exemplify both sweet and savory fillings for use in the invention.

### Savory Fillings

### EXAMPLE 10

### Coconut Curry Shrimp

| Ingredient | Grams |
|---|---|
| Black Tiger Shrimp | 500.00 |
| Coconut Milk | 100.00 |
| Curry Powder | 11.00 |
| Salt | 6.00 |
| Pepper, White | 3.00 |
| Red Peppers, diced | 50.00 |
| Carrots, diced | 50.00 |
| Onion, diced | 50.00 |
| Vinegar | 3.00 |
| Garlic | 7.50 |
| White Rice, cooked | 300.00 |
| Starch | 25.00 |

### EXAMPLE 11

### Honey Sesame Barbeque

| Ingredient | Grams |
|---|---|
| Pork, pulled | 500.00 |
| Vinegar | 50.00 |
| Brown Sugar | 25.00 |
| Honey | 50.00 |
| Sesame Seeds | 15.00 |
| Garlic | 10.00 |
| Salt | 5.00 |
| Tomato Paste | 175.00 |
| Starch | 25.00 |

### EXAMPLE 12

### Andouille Sausage and Peppers

| Ingredient | Grams |
|---|---|
| Andouille Sausage, diced | 500.00 |
| Onions, diced, sauteed | 75.00 |
| Red Peppers, diced, sauteed | 125.00 |
| Green Peppers, diced, sauteed | 125.00 |
| Mozarella Cheese | 250.00 |

### EXAMPLE 13

### Southwest Vegetables and Cheese

| Ingredient | Grams |
|---|---|
| Corn, roasted | 125.00 |
| Red Peppers, roasted | 125.00 |
| Green Peppers, roasted | 125.00 |
| Onions, grilled | 150.00 |
| Chili Peppers | 50.00 |
| Yellow Squash | 125.00 |
| Chipotle Peppers | 50.00 |
| Pepperjack Cheese | 250.00 |
| Starch | 25.00 |
| Olive Oil | 10.00 |
| Salt | 12.00 |

### EXAMPLE 14

### Black Beans and Cheese

| Ingredient | Grams |
|---|---|
| Black beans, cooked | 250.00 |
| Onions, diced | 100.00 |
| Garlic, minced | 10.00 |
| Salt | 5.00 |
| Olive Oil | 10.00 |
| Red Peppers, diced | 100.00 |
| Cheddar Cheese | 125.00 |
| Mozzarella Cheese | 125.00 |
| Starch | 25.00 |

### EXAMPLE 15

### Spinach, Feta and Black Olives

| Ingredient | Grams |
|---|---|
| Spinach, drained | 500.00 |
| Feta Cheese, crumbled | 500.00 |
| Black Olives | 250.00 |
| Olive Oil | 15.00 |
| Black Pepper | 2.00 |
| Salt | 5.00 |
| Garlic | 10.00 |

### Sweet Fillings

### EXAMPLE 16

### Cherry and Almond Filling

| Ingredient | Grams |
|---|---|
| Commercial Cherry Pie Filling | 500.00 |
| Commercial Almond Paste | 150.00 |
| Col-Flo Starch | 30.00 |

### EXAMPLE 17

### Cherry Filling

| Ingredient | Grams |
|---|---|
| Commercial Cherry Pie Filling | 1000.00 |

### EXAMPLE 18

### Apple and Cinnamon Filling

| Ingredient | Grams |
|---|---|
| Commercial Apple Pie Filling | 750.00 |
| Cinnamon | 3.00 |
| Oatmeal | 100.00 |
| Honey | 25.00 |
| Sugar | 25.00 |
| Cloves | 1.00 |
| Col-Flo Starch | 25.00 |

### EXAMPLE 19

### Chocolate and Marshmallow Filling

| Ingredient | Grams |
|---|---|
| Chocolate Chips | 500.00 |
| Marshmallow Crème | 250.00 |

### EXAMPLE 20

### Chocolate and Hazelnut Filling

| Ingredient | Grams |
|---|---|
| Commercial Chocolate | 1000.00 |
| Hazelnut Crème | |

### EXAMPLE 21

### Peanut Butter and Jelly Filling

| Ingredient | Grams |
|---|---|
| Commercial Peanut Butter | 500.00 |
| Commercial Strawberry Jam, | 500.00 |
| Heat Stable | |

### EXAMPLE 22

### Apricot, Date, Walnut and Honey Filling

| Ingredient | Grams |
|---|---|
| Apricots, dried, diced | 250.00 |
| Dates, dried, diced | 250.00 |
| Walnuts, chopped | 150.00 |
| Cinnamon | 5.00 |
| Cloves, ground | 2.00 |
| Honey | 150.00 |
| Col-Flo Starch | 25.00 |

### EXAMPLE 23

Two roughly circular, similarly sized planar portions, substantially as made in Example 1, are combined to form an envelope surrounding the filling of Example 22. About 1 part by weight of the filling is placed on the partially gelatinized layer of the first of the planar food portions to form a filled layer. The second roughly circular planar portion is placed on the filled layer such that the edges of the planar layers are roughly aligned. Due to the self-assembling nature of the partial gelatinization of the layers, the layers form a cohesive bond joining the planar portions at the periphery to form an envelope. The cohesive bond is made more secure by heating the food after assembly. Once cooked the filled envelope is wrapped and packaged for sale.

### EXAMPLE 24

In a continuous process, the slurry substantially similar to that in Example 1 is metered into a 4 mm layer with a 50 cm width on a heated drum (375° F.). The layer has a residence time on the turning drum of about 35 seconds to form the heated gelatinized side and the partially gelatinized opposite side. The layer is passed from the drum to a conveyor. The layer on the conveyor is then cut into circular portions having a weight of about 1 ounce. A fraction of the cut portions are placed onto a separate conveyor. About one ounce of the filling of Example 22 is centered onto the partially gelatinized side of a circular portion. A second similar portion from the separate conveyor is inverted and placed onto the portion with the filling joining the partially gelatinized sides to from an envelope surrounding the filling. The filled envelope is nipped briefly and heated in a pass-through oven at 375° F. to set the envelope cohesive bond between portions. Once cooked the filled envelope is wrapped and packaged for sale.

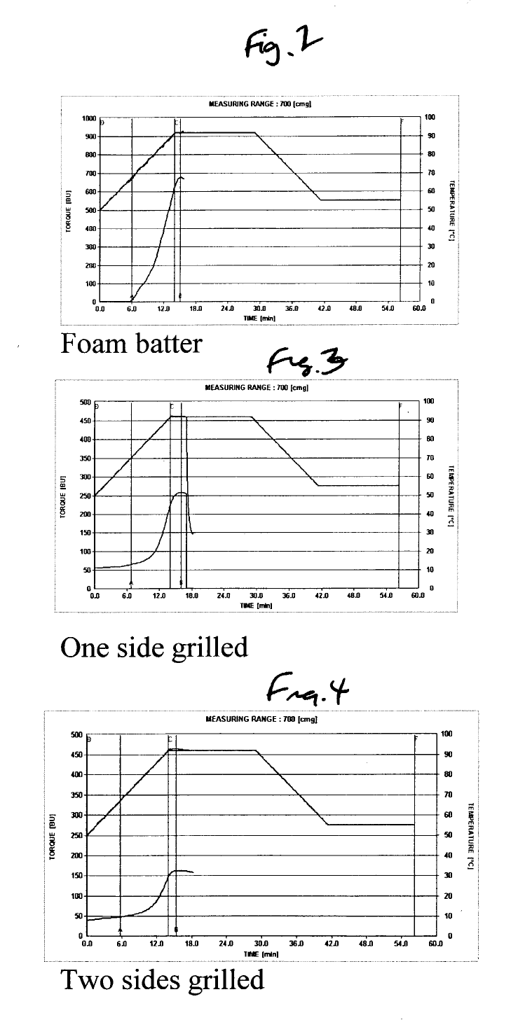

The degree of gelatinization is an aspect that provides the planar food with the capacity to bond and self assemble into an envelope. The degree of gelatinization can be qualitatively gauged by an inspection of the planar food during heating. The directly heated side obtains a cooked nonsticking character while the side not directly heated retains moisture and has reduced gelatinized character. Simply touching the layer with reduced gelatinization and determining if any tack is present in the surface can test this character. As long as the surface retains tack, the surface has less gelatinized character than the heated side. One measure of the degree of gelatinization is the increase in viscosity of the cooked dispersion that can be seen in the Viskograph plots in FIGS. 2 to 4. The graphs represents starch gelatinization, the higher the peak viscosity, the more starch is gelatinized. Our hypothesis was that the more the dispersion material is heated, the more starch within it will be gelatinized, and the lower the Viscograph peak. Three samples were tested, the raw dispersion (very little gelatinization), the dispersion placed on a heated surface heated on one side only (some gelatinization), and the dispersion heated on both sides (more gelatinization). When the amounts tested were standardized on a dry weight basis, our prediction was confirmed. The test results show that the raw batter had the highest Viskograph peak, the two sided heated disk the lowest.

TABLE 1
Tabulated Data from FIGS. 2 to 4

| Sample Identification | Peak Height (BU) |
|---|---|
| Aqueous dispersion no heating | 670 |
| One side cooked | 260 |
| Two sides cooked | 160 |

These test were run on a constant dry weight basis The % solid data was calculated by first calculating the moisture level in the formula (weight water/weight formula). Solids level in the batter was then found by subtracting the moisture % from 100%. To calculate the solids level for the grilled discs, the grilled weight was subtracted from the starting weight. This moisture loss % was then subtracted from the above batter moisture level. This test can be used to characterize the gelatinization extent of the dispersion materials of the invention. The directly heated side having substantially greater gelatinization than the side not directly exposed to the heating source.

The above specification, examples and data provide a complete description of the manufacture and use of the food composition, article and processes of the invention. Since many embodiments of the invention can be made without departing from the spirit and scope of the invention, the invention resides in the claims hereinafter appended.

We claim:

1. A food component comprising an anisotropically heated, aqueous, leavened flour mixture, the flour mixture in the form of a planar food component having a first side and a second side, the first side comprising a substantially gelatinized surface and the second side comprising a partially gelatinized surface.

2. The component of claim 1 wherein the mixture is yeast leavened.

3. The component of claim 1 wherein the thickness of the component is about 2 to 10 millimeters and contains about 0.1 to 4 wt.% fat.

4. The component of claim 1 wherein the thickness of the component is about 2 to 10 millimeters and contains about 15 to 40 wt % water.

5. The component of claim 2 wherein the food has a texture comprises raised bread with closed cell structure the cells having a diameter about 0.1 to 2 mm.

6. The article of claim 1 wherein the planar component comprises a sheet with a width of about 25 to 300 cm and an indeterminate length.

7. The article of claim 1 wherein the planar component has a geometric shaped periphery.

8. The unit of claim 7 wherein the geometric periphery comprises a smooth closed curve shape.

9. The unit of claim 8 wherein the closed curve comprises an ovoid shape.

10. The unit of claim 7 wherein the geometric shape comprises a substantially rectangular shape.

11. The unit of claim 7 wherein the geometric shape comprises a sweet formulation.

12. The unit of claim 7 wherein the geometric shape comprises a savory formulation.

13. A composite food unit comprising a filling surrounded by an envelope, the envelope comprising one planar food component having a first substantially gelatinized side and a second partially gelatinized side wherein the envelope comprises a sealed planar component.

14. The component of claim 13 wherein the mixture is yeast leavened.

15. The component of claim 13 wherein the thickness of the component is about 2 to 10 millimeters and contains about 0.1 to 4 wt.% fat.

16. The component of claim 13 wherein the thickness of the component is about 2 to 10 millimeters and contains about 15 to 40 wt % water.

17. The component of claim 14 wherein the food has a texture comprises raised bread with closed cell structure the cells having a diameter about 0.1 to 2 mm.

18. The article of claim 13 wherein the planar component comprises a sheet with a width of about 25 to 300 cm and an indeterminate length.

19. The article of claim 13 wherein the planar component has a geometric shaped periphery.

20. The unit of claim 19 wherein the geometric periphery comprises a smooth closed curve shape.

21. The unit of claim 20 wherein the closed curve comprises an ovoid shape.

22. The unit of claim 19 wherein the geometric shape comprises a substantially rectangular shape.

23. The unit of claim 19 wherein the geometric shape comprises a sweet formulation.

24. The unit of claim 19 wherein the geometric shape comprises a savory formulation.

25. A composite food unit comprising a filling surrounded by an envelope, the envelope comprising an edible layer and a planar food component having a first substantially gelatinized side and a second partially gelatinized side, wherein the edible layer is joined to the second partially gelatinized side at a portion of the edible layer and a portion of the second partially gelatinized side.

26. The unit of claim 25 wherein the edible layer comprises a bread and the bread and the second partially gelatinized layers are contacted at the periphery.

27. The unit of claim 26 wherein the edible layer comprises a crust layer.

28. The unit of claim 26 wherein the edible layer comprises pasta.

29. The unit of claim 26 wherein the edible layer comprises pita bread.

30. The unit of claim 27 wherein the edible layer comprises a pizza crust and the filing comprises a pizza filling.

31. The unit of claim 25 wherein the unit comprises a sweet filling.

32. The unit of claim 25 wherein the unit comprises a savory filling.

33. The unit of claim 25 wherein the unit comprises an appetizer.

34. The unit of claim 25 wherein the unit comprises a breakfast food.

35. The unit of claim 25 wherein the unit comprises a sandwich food.

36. The unit of claim 25 wherein the unit comprises a sandwich comprising peanut butter and jelly.

37. The unit of claim 25 wherein the periphery of the partially gelatinized side is joined with the periphery of the edible layer.

38. The unit of claim 25 wherein the periphery of the partially gelatinized side is joined with the periphery of the edible layer and additionally comprises a food grade adhesive.

39. A composite food unit comprising a filling surrounded by an envelope, the envelope comprising a first planar food component and a second planar food component, each planar food components having a first substantially gelatinized side and a second partially gelatinized side, wherein the first planar food component is joined to the second planar food component at a portion of the partially gelatinized side of the first component in contact with a with a portion of the partially gelatinized side of the second component.

40. The food unit of claim 39 wherein the components are joined at the periphery of the partially gelatinized sides of both food components.

41. The unit of claim 39 wherein the food unit comprises a pizza and the filing comprises a pizza filling.

42. The unit of claim 39 wherein the unit comprises a sweet filling.

43. The unit of claim 39 wherein the unit comprises a savory filling.

44. The unit of claim 39 wherein the unit comprises an appetizer.

45. The unit of claim 39 wherein the unit comprises a breakfast food.

46. The unit of claim 39 wherein the unit comprises a sandwich food.

47. The unit of claim 39 wherein the envelope comprises about 0.1 to 4 wt.% fat.

48. The unit of claim 39 wherein the envelope comprises about 15 to 40 wt % water.

49. A method of making a planar food component comprising a layer having a first side having a substantially gelatinized character and a second side having a partially gelatinized character; the process comprising:
(a) forming an aqueous yeast leavened flour mixture having a fermented character;
(b) forming the aqueous mixture into a substantially planar form; and
(c) anisotropically heating the mixture,
wherein the heating forms a planar food component having a substantially gelatinized first surface and a partially gelatinized second surface.

50. The method of claim 49 wherein the planar food component comprises a sheet having a width of 25 to 300 cm and an indeterminate length.

51. The method of claim 49 wherein the planar food component is cut into a geometric shaped periphery.

52. The method of claim 51 wherein the geometric profile comprises a closed smooth curve shape.

53. The component of claim 51 wherein the profile comprises a substantially rectangular shape.

54. The method of claim 50 wherein the sheet is cut to a shape.

55. A method for manufacturing a composite food having a filling within an envelope, the method comprising the steps of placing a filling portion within the periphery of a first planar food component to form a filled layer and contacting the filled layer with a second planar food component, each food component comprises a first layer and a second layer, the first layer comprising a substantially gelatinized surface, the second layer comprising a partially gelatinized surface, and sealing the first and the second layers by contacting the semi-gelatinized layers at the periphery.

56. The method of claim 55 wherein the food is heated to seal the periphery.

57. The method of claim 55 wherein the layers are cut to form a periphery comprising a geometric shaped periphery.

58. The method of claim 55 wherein the geometric shape comprises a closed smooth curve shape.

59. The method of claim 55 wherein the geometric shape comprises a substantially rectangular shape.

60. The unit of claim 55 wherein the food comprises a pizza and the filing comprises a pizza filling.

61. The unit of claim 55 wherein the food comprises a sweet filling.

62. The unit of claim 55 wherein the food comprises a savory filling.

63. The unit of claim 55 wherein the food comprises an appetizer.

64. The unit of claim 55 wherein the food comprises a breakfast food.

65. The unit of claim 55 wherein the food comprises a sandwich food.

66. The unit of claim 55 wherein the envelope comprises about 0.1 to 4 wt.% fat.

67. The unit of claim 55 wherein the envelope comprises about 15 to 40 wt % water.
